(19) United States
(12) Patent Application Publication
(10) Pub. No.: US 2015/0211972 A1
(43) Pub. Date: Jul. 30, 2015

(54) Shear Stress Sensor

(71) Applicants: Chistopher Hughes, Altamonte Springs, FL (US); Kareem Ahmed, Virgina Beach, VA (US); Shizhi Qian, McLean, VA (US)

(72) Inventors: Chistopher Hughes, Altamonte Springs, FL (US); Kareem Ahmed, Virgina Beach, VA (US); Shizhi Qian, McLean, VA (US)

(21) Appl. No.: 14/576,678

(22) Filed: Dec. 19, 2014

Related U.S. Application Data
(60) Provisional application No. 61/918,045, filed on Dec. 19, 2013.

(51) Int. Cl. G01N 11/02

(52) U.S. Cl. CPC G01N 11/02

(57) ABSTRACT

A shear stress sensor for use within a substrate exposed to a fluid flow. The sensor comprising a cavity defined within the substrate; electrolyte fluid within the cavity; and an amperometric system further comprising oppositely disposed first and second electrodes within the cavity for measuring current flow between the first and second electrodes, wherein fluid motion within the cavity is responsive to shear stress and measured current flow is responsive to the fluid motion.

### CROSS REFERENCE TO RELATED APPLICATIONS

This patent application claims the benefit under Section 119(e) of the provisional patent application assigned Application No. 61/918,045 filed on Dec. 19, 2013, which is incorporated by reference herein.

### STATEMENT REGARDING FEDERALLY SPONSORED RESEARCH OR DEVELOPMENT

This invention was made with Government support under contract NNX14CL56P awarded by NASA. The Government has certain rights in the invention.

### FIELD OF THE INVENTION

The present disclosure relates to a device for the sensing shear stress of a fluid flow and, more particularly, a micro-fluidic shear stress sensor.

### BACKGROUND

Shear stress on the surface of a vehicle is directly proportional to the friction imposed by the vehicle skin. Minimizing friction is a common goal in aerospace applications. Skin friction drag may be 50% of total drag for some subsonic aircraft. If commercial airlines were able to realize a 5% increase in efficiency, the industry could realize billions of dollars in fuel savings. Due to the nature of the shear stress measurement process, conventional approaches have never been able to achieve sufficiently sensitive, high resolution measurements.

The shear stress can be expressed mathematically by the equation below, where μ is the dynamic velocity, u is the fluid velocity parallel to the surface of interest, and du/dy is the gradient of the fluid flow close to the surface or at y=0, where y is in the direction perpendicular to the surface.

$$\begin{matrix}{τ}_{w} = μ \frac{\partial u}{\partial y} \vert y \\ = 0\end{matrix}$$

Some approaches to measuring shear stress have focused on shear sensors using micro-posts. While micro-posts may be easily integrated onto surfaces, they require external hardware to sense flow. In addition, micro-posts present certain fabrication challenges and flow through gaps in the micro-posts can create significant measurement errors.

Other approaches have used micro-electrical mechanical systems (MEMS). These generally fall into three categories: thermal, floating element, and optical shear-stress sensors. Prior efforts have shown promising directional sensitivity to a level of about 1 Pascal. However, such efforts have suffered a number of challenges. First, MEMS shear sensors have proven complicated and expensive to manufacture, being subject to misalignment or gaps within packaging. Existing MEMS shear sensors are a compromise between measurement of local properties and size of elements, sensitivity to the effects of temperature changes or thermal characteristics of the sensed flow media, dust or oil particles, and electromagnetic radiation. The effects of dust or oil particles render them unsuitable for use with oil droplet particle image velocimetry (PIV).

None of the existing sensors have been commercialized due to issues with sensitivity, accuracy, and reliability. Each of these issues stem from the complexities of MEMS manufacturing processes and moving parts at the micron scale level.

### SUMMARY

The present inventive system is directed to a microfluidics-based shear stress sensor. In one embodiment the sensor comprises a well of a depth and diameter on the order of about 2 mm. Generally, the range of sensitive shear stress measurements increases as the diameter decreases (e.g., about 100 Pa to 10 kPa for a 500 micrometer well). The 2 mm cavity is sensitive to about 100 mPa. The well may be filled with an electrolytic fluid, which may be sourced from a reservoir in fluid communication with the well. An amperometric sensor may be disposed within the well to detect changes in ionic current within the well. The shear stress of the external gaseous fluid will create a convective flux inside the well. Measured ionic current is proportional to a change in convective flux inside such a well, which is in turn responsive to the shear stress and thereby provides an effective measurement of that shear stress.

Generally the cavity depth can extend from about 500 microns to about 1.8 mm. Also, an operational depth generally depends on whether the electrodes of the amperometric sensor are oriented parallel or planar. Cavities having parallel electrodes can be deeper if the electrodes are placed close to the surface.

Since there is no known equation that directly provides a shear stress value based on the measured ionic current, the inventors have developed a correlation between convective flux values and an electrochemical signal from the shear stress sensor and also developed a correlation between shear stress values and convective flux values. By combining these two empirical relationships, the inventors have in effect developed an empirical relationship between shear stress and the electrochemical signal from the shear stress sensor. The empirical relationship is generally specific to each cavity design.

### BRIEF DESCRIPTION OF THE DRAWINGS

FIG. 1A is a graph that depicts a relationship between convective flux values and electrochemical signal values.

FIG. 1B is a graph that depicts a relationship between wall shear stress values and convective flux values.

FIG. 1C is a graph that depicts a relationship between wall shear stress values and electrochemical signal values.

FIG. 2 is a schematic illustration of an aspect of a first embodiment of the sensor of the present invention.

FIG. 3 is a schematic illustration of an aspect of a second embodiment of the sensor of the present invention.

FIG. 4 is a schematic illustration of an aspect of computer implementation of the sensor of the present invention.

### DETAILED DESCRIPTION

### Introduction

Disclosed is a micro-fluidic shear stress sensor for measuring the shear stress of a fluid flowing over a surface, for example a surface of an aircraft. A no-slip condition requires that shear stress from air flow be applied to a free surface. A fluid, by definition, will move in response to any shear stress.

In one embodiment, the present approach utilizes an electrolyte micro-fluid material disposed within a well within the surface. The electrolyte micro-fluid material is subjected to a fluid flow stream and measures the internal convection within the electrolyte fluid to thereby quantify shear stress in the fluid flow stream.

In one embodiment, the shear stress sensor may comprise a ring disposed within an opening of a surface of a substrate. The term “ring” means sufficient structure to form an inner side surface surrounding, defining, or forming such a well of a desired shape when inserted into the substrate. The ring opening is disposed along the surface of the substrate. Thus, the ring and the inner well surface form a cavity within the substrate with the ring opening or aperture parallel to or facing the gaseous fluid flow stream. That is, in operation the top surface of the well is parallel to the flow stream. A bottom surface of the well is formed for a desired application; for example, the well may be designed to hold a micro-drop of electrolyte fluid.

This well is configured, situated, or adapted to receive or hold a liquid electrolyte, a micro-drop for example. The ring may be formed, for example, by laser drilling, etching, electron discharge, electron beam forming or another machining operation as appropriate for a solid substrate, or by an assembly of components for achieving the desired effect that are then disposed within the substrate.

An electrolyte reservoir may be provided in fluid communication with the well for supplying electrolyte fluid to the well.

In some embodiments, the inner well surface may be hydrophilic, i.e., formed from a hydrophilic material, while the outer well surface of the sensor ring may be hydrophobic, i.e., formed of a hydrophobic material.

The well may be filled with a liquid electrolyte fluid so as to have a nearly flat liquid electrolyte surface at a top of the well.

In some embodiments, the well may have a depth and diameter on the order of about 2 mm. Given this size, it is expected that the electrolyte fluid in the well may form a micro-drop with a top hemispheric diameter of the electrolyte fluid on the order of about 100 microns or less. At this scale, surface tension forces outweigh all other concerns so that those other forces may be safely ignored. That is, the electrolyte fluid will remain in the open well due to the surface tension forces.

However, for certain fluids the evaporation rate may be too great and thus a membrane is used to close the cavity and thereby retain the electrolyte fluid within the well. A material of the membrane must be sufficiently flexible to transfer the shear stress forces to the electrolyte fluid within the cavity.

The shear stress sensor may include an amperometric system configured to detect change in ionic current within the electrolyte fluid. The amperometric system may have a circuit with a first electrode and a second electrode, such that the first electrode may be an anode and the second electrode may be a cathode. The first and second electrodes may be disposed or patterned along the inner well surface for accurate detection, i.e., located within the well in opposing, predetermined positions. The amperometric system may also include a power supply or voltage source within a circuit in electrical communication with at least one of the first and second electrodes. The circuit may also include a ground, such that the first electrode may be at a desired positive voltage and the second electrode may be at a ground potential. Other embodiments may also include a reference electrode.

The shear stress due to fluid flow of the external fluid across the substrate creates a convective flux in the electrolyte fluid within the well. The first and second opposing electrodes may detect any change in ionic current, which will be proportional to any change in the convective flux. In this manner the change in ionic current may be used to detect and determine shear stress experienced by the electrolyte fluid.

### Principles of Operation

The present system is an advance over conventional methods of determining shear stress, providing an effective sensor of shear stress in a gaseous or liquid, inert fluid. The simplicity of the device described herein reduces the expense and difficulty of manufacture, as well as enabling scalability. The present device also overcomes many of the above-described disadvantages with MEMS. The resolution provided by the sensor depends on amperometric techniques, as opposed to device geometry. A decrease in sensor size results in an increased electric field between the electrodes that may provide an increase in sensor sensitivity. A decrease in size also increases the range of shear stresses that can be measured due to changes in vibration characteristics of the membrane that covers the cavity in some embodiments.

### Surface Tension

In an embodiment that does not utilize a membrane to close the well, the electrolyte fluid remains in the well in part due to surface tension. However, as mentioned elsewhere herein due to fluid evaporation, a membrane to retain the fluid in the well may be desired and is in fact required in certain applications. It is generally true that surfactant-free electrolytes have higher surface tension than a water solvent. For simplicity and conservatism, the surface tension (y) of water can be used in most calculations related to the present invention. At room temperature, the surface tension of water is about 0.073 N/m.

### Gravity and Acceleration

The acceleration of the micro-drop due to gravity or other factors can be safely ignored. The effect of acceleration on the micro-drop can be considered negligible if the dimensionless Bond number, which is known to those skilled in the art, is much less than 1.

### Drop and Membrane Geometry

Membrane curvature is generally proportional to the pressure gradient; the surface tension between liquid and the gas flow will generally not have a role in the membrane curvature. One may be able to tune the curvature of the membrane according to the pressure gradient across the hemisphere surface. For some embodiments in high pressure environments, it may be necessary to compensate for this pressure.

In addition, some embodiments call for a hydrophobic exterior well surface and a hydrophilic interior well surface. It is believed that this will help ensure the micro-drop does not easily escape the well.

### Sensing Mechanism.

An aspect of the present approach is to detect and quantify shear stress in a gaseous medium, such as air. A no slip condition requires that shear stress from the air flow be applied to the free surface over which the air flow streams. In addition, a fluid by definition will move in response to any shear stress. It is this motion that causes internal convection of the electrolyte and a resulting change in ionic current. This ionic current can be measured and is directly proportional to the air flow shear stress.

The use electrochemistry to measure the convection in a fluid within a shear stress sensor is an aspect of the present approach. Amperometry may have applications in other fields, such as a determination of fluid velocity; however, it is believed that this is its first application to microfluidic shear stress sensors. An amperometric electrical configuration may be used to measure the change in current produced by the change in flux of ionic species, where the change in flux is related to the shear stress.

The flux of an ionic species is described by the Poisson-Nernst-Planck relationship:

Nᵢ=−D_{AB}∇cᵢ+mᵢzᵢcᵢE+cᵢV

where
N=ionic flux
subscript i=ionic species of interest
D_{AB}=Diffusion coefficient of material A into material B
c=concentration
m=mass
z=valence of ionic species
E=Electric field vector
V=Convective flux vector

The first term in the equation above is the diffusion of an ionic species, the second term is the electrical migration due to an applied electric field, and the final term is the convection of the species. It can be seen that for steady state conditions, the diffusion and electrical migration terms are constant and any changes in the ionic flux are completely due to the convection of the electrolyte fluid, i.e., the last term in the equation.

From electrostatics (ignoring any induced magnetic field), the relationship of the ionic flux to current density is given by:

$$J = F {\sum }_{i}^{n} {z}_{i} {N}_{i}$$

where
F=Faraday's constant
J=current flux

Thus, current density in an ionic circuit is completely dependent on ionic flux (N), instead of on the flux of electrons. With a constant ion concentration, each ion in the solution will attempt to approach its migration velocity, which is dependent on the electric field. The effect of electrostatic interactions of the ion with counter ions will limit this migration velocity. With an addition of the hydrodynamic velocity, the total ionic flux will increase or decrease dependent on the direction of flow.

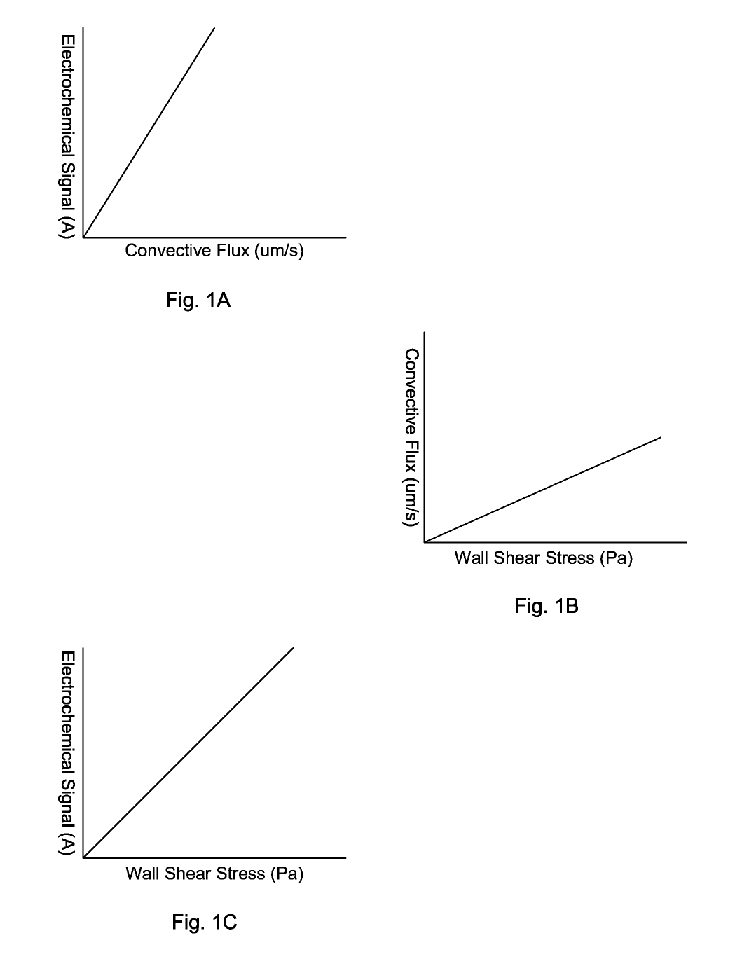

Thus the inventors have developed various empirical relationships, for different ionic species and different cavity designs, for example, that depict a relationship between convective flux values (um/s) and electrochemical signal values (A) in FIG. 1A and an empirical relationship that depicts a relationship between wall shear stress values (Pa) and convective flux values (um/s) as shown in FIG. 1B. FIG. 1C combines FIGS. 1A and 1B and depicts a relationship between wall shear stress values (Pa) and electrochemical signal values (A).

From the Poisson-Nernst-Planck equation above, it can be seen that the sensitivity of the proposed sensor is dependent on the electric field applied to the electrolyte solution. If the electric field is too large, then the convective ion flux will have little effect on the total flux. If the electric field is too small, then the amperometric sensor will have too little current to differentiate or sense a current density due to the convective ion flux.

If necessary, a reduction-oxidation electrode may be added to the device to provide a concentration gradient. This would further increase device sensitivity to shear stresses.

Because a working sensor uses fluid, it is contemplated that the device may be sensitive to very small shear stress (e.g., <<1 Pa). In addition, the device may be scaled down in size further. A practical lower limit of device size is expected to be manufacturing and electric field considerations.

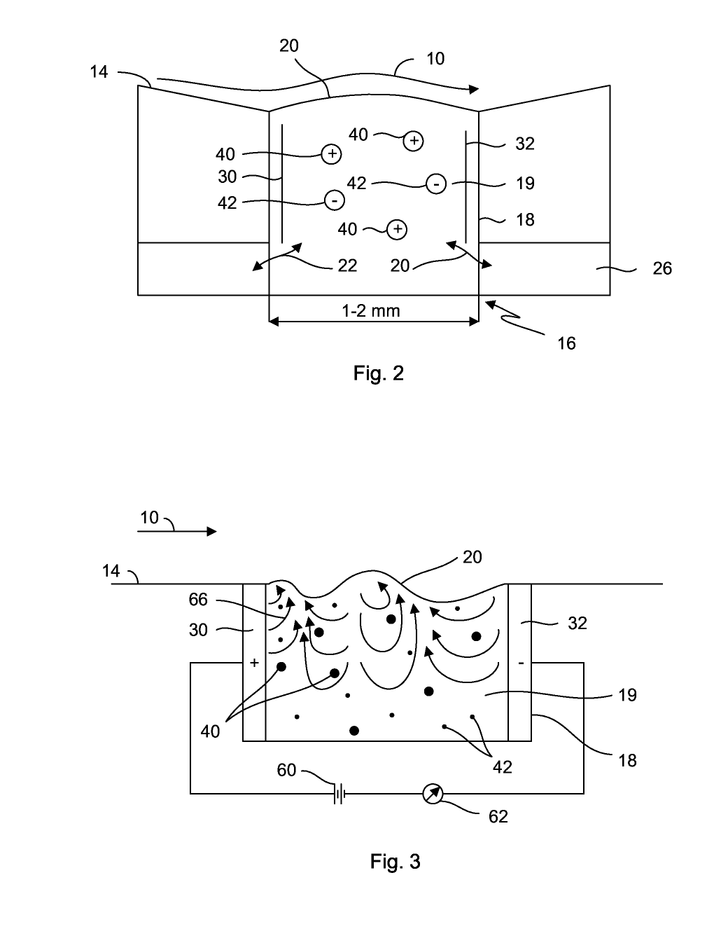

FIG. 2 depicts a shear stress sensor according to one embodiment of the invention. An air flow, as indicated by an arrowhead 10, flows over a surface 14. A sensor 16 is embedded in the surface 14.

The sensor 16 comprises a cavity 18 containing a fluid 19, preferably an electrolyte solution (i.e., one that ionizes when dissolved in a suitable ionizing solution), disposed within the cavity 18. The cavity 18 is closed by a membrane 20 depicted along a top surface of the cavity 18. The cavity 18 is on the order of about 1 to 2 millimeters as shown. Preferably the sensor 16 is circular in construction and thus the dimensions refer to a cavity diameter.

In one embodiment a material of the membrane 20 comprises low density polyethylene about 12 microns thick. Any homogenous organic or inorganic membrane that is both thin and flexible will work. For example, such organic membrane materials comprise polyimide, polyamide, and polypropylene, in addition to the aforementioned polyethylene. Certain fluoropolymers may also be used.

In certain applications and embodiments the membrane 20 may not be required as the fluid 19 is retained within the cavity 18 by surface tension forces.

In one embodiment the fluid 19 within the cavity 18 is replenished, as depicted by arrowheads 20 and 22, from a fluid reservoir 26.

The sensor 16 comprises two plates 30 and 32 within the cavity 18 and attached to a voltage source, not shown, for applying an electric field across the cavity 18. Positive ions 40 and negative ions 42 are further illustrated within the cavity 18.

The membrane 20 is relatively flat in a quiescent condition, but when exposed to an external air flow, as represented by the arrowhead 10, is deflected as shown and induces fluidic motion within the fluid 19. This fluidic motion changes the conductance of the fluid, i.e., the electrolyte solution.

By measuring the electrical current flowing through the fluid 19 (at a fixed voltage) the shear stress can be determined as described above.

The inventors propose to generate sufficient data from many trials at different values of shear stress and for different cavity dimensions to identify empirical relationships between the wall shear stress and the electrochemical output or the value measured by the biopotentiostat for each one of the different cavity dimensions.

For example, a computer processor, as described below, can be programmed to supply the shear stress value based on an electrochemical value or the value measured by the biopotentiostat. Generally, the empirical relationships are essentially a curve fit to the data and will be different for each cavity type. As described elsewhere herein, the different values of shear stress will create different convections within the cavity.

FIG. 3 depicts a more detailed schematic of the sensor 16, including a voltage source 60 for applying an electric field between the plates 30 and 32, and a bipotentiostat 62 for measuring the change in current at the electrode surface due to the convection within the well 18. This concept is also referred to as electrochemical velocimetry. A convective flux field 66, as caused by the shear stress within the fluid 19, is also shown.

Centers of rotation or centers of vortexes may be formed within the electrolyte fluid 19. These centers of rotation indicate flow structures within the fluid 19 under different conditions. Computer implemented systems

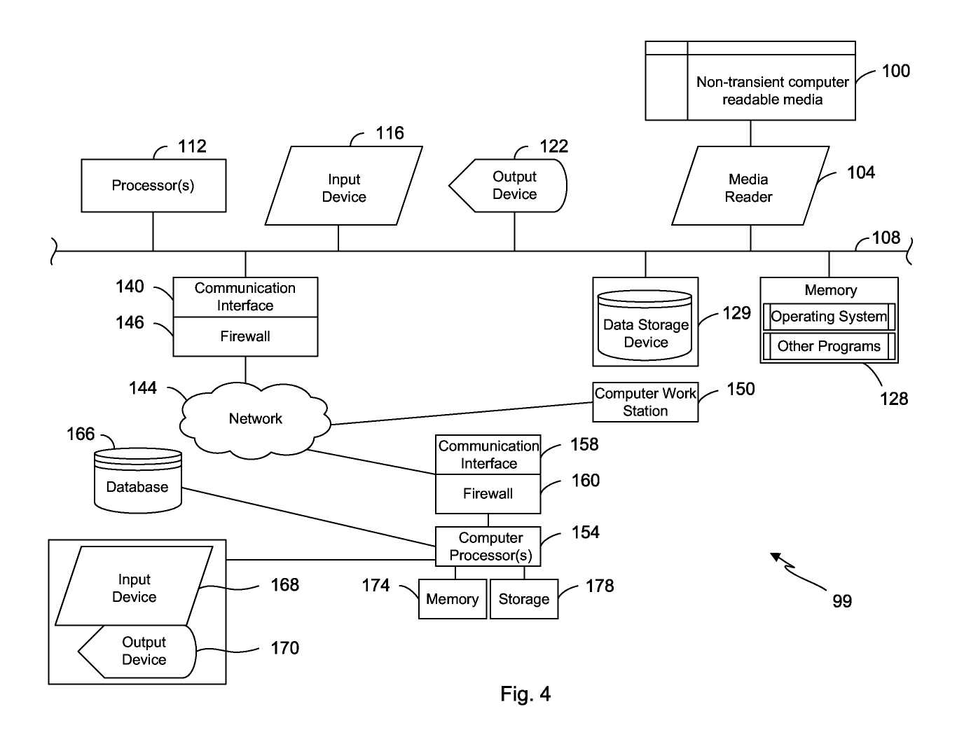

As will be appreciated by one of skill in the art, aspects or portions of the present approach may implemented by a computer based system, whether as a method, system, or at least in part, on a computer readable medium. Accordingly, the present approach may take the form of combination of hardware and software embodiments (including firmware, resident software, micro-code, etc.) or an embodiment combining software and hardware aspects that may all generally be referred to herein as a “circuit,” “module” or “system.” Furthermore, the present approach may take the form of a computer program product on a computer readable medium having computer-usable program code embodied in the medium. The present approach might also take the form of a combination of such a computer program product with one or more devices, such as a modular sensor, systems relating to communications, control, or an integrate remote control component, etc. The present device described above may symbolically take the form of an Input Device as depicted, for example, in FIG. 4.

For computer programming support, any suitable non-transient computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the non-transient computer-readable medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a device accessed via a network, such as the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any non-transient medium that can contain, store, communicate, propagate, or transport the program for use by or in connection with the instruction execution system, apparatus, or device.

Computer program code for implementing or carrying out operations of the present sensor may be written in an object oriented programming language such as Java, C++, etc. However, the computer program code for carrying out operations of the present approach may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present approach may be described with reference to flowchart illustrations and/or block diagrams of methods, apparatus (systems) and computer program products according to embodiments of the approach. It will be understood that each block of a flowchart illustration and/or block diagram may be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

Any computer program instructions may also be stored in a non-transient computer-readable memory, including a networked or cloud accessible memory, that can direct a computer or other programmable data processing apparatus to function in a particular manner, such that the instructions stored in the computer-readable memory produce an article of manufacture including instruction means which implement the function/act specified in the flowchart and/or block diagram block or blocks.

Any computer program instructions may also be loaded onto a computer or other programmable data processing apparatus to specially configure it to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

Any prompts associated with the present approach may be presented and responded to via a graphical user interface (GUI) presented on the display of the mobile communications device or the like. Prompts may also be audible, vibrating, etc.

Any flowcharts and block diagrams in the Figures illustrate the architecture, functionality, and operation of possible implementations of systems, methods and computer program products according to various embodiments of the present approach. In this regard, each block may alternatively represent a module, segment, or portion of code, which comprises one or more executable instructions for implementing the specified logical function(s). It should also be noted that, in some alternative implementations, the functions noted in a block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

With specific reference to a computer system 99 of FIG. 4, a computer program is stored in a non-transient computer readable media 100 and conveyed to a media reader 104. The media reader 104 is connected via a bus 108 to a processor 112, input device 116, and an output device 122. A memory 128 for storing other software programs and an operating system is also connected to the bus 108. Data can also be accessed from and sent to a date storage device 129, also connected to the bus 108.

A communications interface 140 is also connected to the bus 108 and to a network 144 via a firewall 146.

A computer work station 150 and computer processor(s) 154 (operating through a communication interface 158 and a firewall 160) are also connected to the network 144. A database 166, input/output devices 168/170, memory 174, and storage components 178 are also connected to the processor(s) 154.

Together with the description provided above, those skilled in the art understand the functionality and interrelationships set forth in FIG. 4. For example, such a computer system 99 can be used to determine the shear stress of a fluid air flow 10 based on measured current values by a biopotentiostat 62.

The terminology used herein is for the purpose of describing particular embodiments only and is not intended to be limiting of the approach. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although the teachings of the invention have been described with respect to an air stream flowing over a substrate, the teachings can also be applied to shear stress values created by liquid flow streams. However, application to the latter fluid requires the development of separate calibration data for determining the shear stress based on the convective flux and the measured current.

The invention may be embodied in other specific forms without departing from the spirit or essential characteristics thereof. The present embodiments are therefore to be considered in all respects as illustrative and not restrictive, the scope of the invention being indicated by the claims of the application rather than by the foregoing description, and all changes which come within the meaning and range of equivalency of the claims are therefore intended to be embraced therein.

What is claimed is:

1. A shear stress sensor for use within a substrate exposed to a fluid flow, the sensor comprising:
a cavity defined within the substrate;
electrolyte fluid within the cavity; and
an amperometric system further comprising oppositely disposed first and second electrodes within the cavity for measuring current flow between the first and second electrodes, wherein fluid motion within the cavity is responsive to shear stress and measured current flow is responsive to the fluid motion.

2. The shear stress sensor of claim 1 wherein the fluid flow comprises a gaseous fluid flow.

3. The shear stress sensor of claim 1 further comprising a fluid reservoir in fluid communication with the cavity for replenishing the electrolyte fluid.

4. The shear stress sensor of claim 1 wherein the electrolyte fluid comprises a micro drop of electrolyte fluid.

5. The shear stress sensor of claim 1, wherein the amperometric system circuit further comprises a voltage source in electrical series with the first and second electrodes and a bipotentiostat for determining a current in the circuit.

6. The shear stress sensor of claim 5, wherein the amerpometric system circuit further comprises a ground point.

7. The shear stress sensor of claim 1 the first electrode being an anode and the second electrode being a cathode.

8. The shear stress sensor of claim 1 wherein an inner surface of the cavity is hydrophilic and an outer surface of the cavity is hydrophobic.

9. The shear stress sensor of claim 1 wherein the cavity has a diameter of between about 1 and 2 millimeters and a depth of greater than about 500 microns.

10. The shear stress sensor of claim 1 further comprising a sensor ring within the cavity.

11. The shear stress sensor of claim 1, wherein the cavity is adapted to receive a microdrop of an electrolyte fluid.

12. The shear stress sensor of claim 1 further comprising a membrane closing a top surface of the cavity for retaining the electrolyte fluid within the cavity.

13. The shear stress sensor of claim 12 wherein a material of the membrane comprises a low density polyethylene.

14. A shear stress sensor for use within a substrate exposed to a fluid flow, the sensor comprising:
a cavity defined within the substrate;
electrolyte fluid within the cavity;
a fluid reservoir in fluid communication with the cavity for replenishing the electrolyte fluid;
a membrane closing a top surface of the cavity for retaining the electrolyte fluid within the cavity; and
an amperometric system further comprising:
oppositely disposed first and second electrodes within the cavity for measuring a current between the first and second electrodes;
a voltage source in a serial electrical communication with the first and second electrodes; and
a bipotentiostat for determining current flow in the circuit, wherein shear stress of the fluid flow is responsive to measured current flow.

15. The shear stress sensor of claim 14 wherein the electrolyte fluid comprises a micro drop of electrolyte fluid.

16. The shear stress sensor of claim 14 wherein an inner surface of the cavity is hydrophilic and an outer surface of the cavity is hydrophobic.

17. The shear stress sensor of claim 14 wherein the cavity has a diameter of between about 1 and 2 millimeters and a depth of greater than about 500 microns.

18. The shear stress sensor of claim 14 wherein a material of the membrane comprises a low density polyethylene.

19. A sensor for use in determining convective action within a fluid, the convective action due to a fluid flow stream over the sensor, the sensor comprising:
a cavity defined within the substrate;
electrolyte fluid within the cavity; and
an amperometric system further comprising oppositely disposed first and second electrodes within the cavity for measuring current flow between the first and second electrodes, wherein the measured current flow is responsive to the convective action within the fluid.

20. The sensor of claim 19 wherein the fluid flow stream comprises a gaseous or a liquid fluid flow stream.
